(19) United States
(12) Patent Application Publication
(10) Pub. No.: US 2014/0227151 A1
(43) Pub. Date: Aug. 14, 2014

(54) RECOVERY AND PURIFICATION OF MONOVALENT SALT CONTAMINATED WITH DIVALENT SALT

(71) Applicant: Board of Regents, The University of Texas System, Austin, TX (US)

(72) Inventor: Thomas Davis, El Paso, TX (US)

(73) Assignee: Board of Regents, The University of Texas System, Austin, TX (US)

(21) Appl. No.: 14/180,705

(22) Filed: Feb. 14, 2014

Related U.S. Application Data
(60) Provisional application No. 61/764,645, filed on Feb. 14, 2013.

(51) Int. Cl. B01D 61/44; B01D 61/58; C22B 26/10; B01D 61/02

(52) U.S. Cl. CPC B01D 61/44; B01D 61/027; B01D 61/58; C22B 26/10
USPC 423/1; 204/518; 204/520; 204/627; 204/630; 210/321.6; 422/256

(57) ABSTRACT

A method and system for improving the quality and quantity of a soluble salt recovered from the supernatant produced when concentrated solutions are mixed to precipitate an insoluble salt are disclosed. Liquid residual, or supernatant, contains salt that is reusable in the regeneration solution of ion removal devices such as ion exchange or electrodialysis metathesis (EDM). The disclosed embodiments include a method for concentration and purification of salt. NaCl is recovered in a truly Zero Discharge Desalination (i.e., ZDD) process. The ZDD process utilizes reverse osmosis (RO) or nanofiltration (NF) for the primary desalination of groundwater that has high concentration of CaSO4 and utilizes EDM to separately remove calcium and sulfate ions from the RO or NF concentrate so that water recovery can be improved. The recovered NaCl is reused in the EDM.

### CROSS-REFERENCE TO PROVISIONAL APPLICATION

This non-provisional patent application claims the benefit under 35 U.S.C. §119(e) of U.S. Provisional Patent Application Ser. No. 611764,645 filed on Feb. 14, 2013, entitled “RECOVERY AND PURIFICATION OF MONOVALENT SALT CONTAMINATED WITH DIVALENT SALT,” which is hereby incorporated by reference in its entirety.

### FIELD OF THE INVENTION

The disclosed embodiments relate to recovering a purified soluble salt. The disclosed embodiments also relate to continuously withdrawing a stream of a batch solution and treating the withdrawn solution with a salt recovery device.

### BACKGROUND

Desalination is a water purification process often used in regions with abundant unsuitable water with high salinity concentrations. Desalination plants utilize thermal, electrical, or mechanical energy to separate water from salts. Factors influencing use of desalination include salinity levels in raw water, quantities of water needed, and the form of available energy.

Brackish water used in desalination often contains sodium and chloride, along with calcium and magnesium. Desalination of brackish water is constrained by ionic solubility. Calcium and magnesium salts of sulfate and carbonate are considerably less soluble than sodium chloride. During desalination when water is extracted, these cations and anions are concentrated until solubility limitations are reached, followed by precipitation.

Unwanted precipitates, such as calcium sulfate scale, can form in the desalination process, especially on the surface of desalination equipment. Scale formation often degrades desalination system performance by disrupting heat transfer efficiency, water flow restriction, membrane damages, and clogging system components. For example, calcium sulfate is typically present in saline water and has relatively low solubility in water. Thus, calcium sulfate precipitates in a desalination process when its concentration is allowed to exceed its solubility. For example, in evaporation processes, reduced solubility of calcium sulfate at elevated temperatures at heat exchange surfaces causes local supersaturation of calcium sulfate. In processes utilizing reverse osmosis and nanofiltration (NF), conditions of calcium sulfate supersaturation can exist at the membrane surface following buildup of ion concentrations in the boundary layer. Brackish groundwater often contains enough calcium and sulfate ions to limit the amount of fresh water that can be recovered by desalination. Prior proposed solutions also fail to disclose a method for concentration and purification of a salt, or precipitate.

Based on the foregoing, a need exists for a process for recovering a purified soluble salt from an aqueous solution of the salt contaminated with a salt of limited solubility wherein a batch of the soluble salt solution is in contact with crystals of the salt of limited solubility.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, an aspect of the disclosed embodiments to recover a purified soluble salt from an aqueous solution.

It is a further aspect of the disclosed embodiments to continuously withdraw a stream of the batch solution and treating the withdrawn solution with a salt recovery device.

The above and other aspects can be achieved as is now described. A method and system for improving the quality and quantity of a soluble salt recovered from the supernatant produced when concentrated solutions are mixed to precipitate an insoluble salt are disclosed. Liquid residual, or supernatant, contains salt that is reusable in the regeneration solution of on removal devices such as on exchange or electrodialysis metathesis (EDM). The disclosed embodiments include a method for concentration and purification of salt. NaCl is recovered in a truly Zero Discharge Desalination (i.e., ZDD) process. The ZDD process utilizes reverse osmosis (RO) or nanofiltration (NF) for the primary desalination of groundwater that has high concentration of CaSO4 and utilizes EDM to separately remove calcium and sulfate ions from the RO or NF concentrate so that water recovery can be improved. The recovered NaCl is reused in the EDM.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates an exemplary graphical illustration of gypsum solubility at 70° C. in NaCl and MgCl₂ solutions, in accordance with the disclosed embodiments;

FIG. 2 illustrates an exemplary graphical illustration of gypsum solubility at 38° C. in NaCl solutions with increasing concentration of MgCl₂, in accordance with the disclosed embodiments;

FIG. 3 illustrates an exemplary process flow diagram of electrodialysis (ED) recovery of NaCl from a batch of supernatant, in accordance with the disclosed embodiments;

FIG. 4 illustrates an exemplary graphical illustration of solubility of CaSO₄ at 28° C. in NaCl solutions and the resulting Na/Ca ratio, in accordance with the disclosed embodiments;

FIG. 5 illustrates an exemplary flow chart of the zero discharge desalination process with NaCl recovery in ED2, in accordance with the disclosed embodiments; and

FIG. 6 illustrates an exemplary graphical illustration of solubility of CaSO₄ in NaCl solutions at 28° C., in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A method and system for improving the quality and quantity of a soluble salt recovered from the supernatant produced when concentrated solutions are mixed to precipitate an insoluble salt are disclosed. Liquid residual, or supernatant, is reusable in a regeneration solution. The disclosed embodiments include a method for concentration and purification of salt. NaCl is recovered in a truly Zero Discharge Desalination (i.e., ZDD) process. The ZDD process utilizes reverse osmosis (RO) or nanofiltration (NF) for the primary desalination of groundwater that has high concentration of CaSO₄.

No method for concentration and purification of salt in brackish water is suggested in prior proposed solutions. Rather than using a commercially available sodium chloride brine solution to regenerate ion-removal devices, the system may use or incorporate sodium chloride brine solutions produced by the desalination process. The regeneration solution represents the purified and concentrated NaCl recovered by electrodialysis and/or ion-exchange columns or ion-removal devices. It is further noted that the supernatant from the disclosed precipitation system may be usable as a regeneration solution for the disclosed ion-exchange resin, but may require additional processing such as removal of precipitated solids by settling or filtration, or adjustment of pH or ion concentration. Brackish water frequently contains significant amounts of calcium, magnesium, sulfate, and carbonate. Each cation could be separated and combined with an anion to produce a salt that could be used for commercial purposes rather than treated as a waste product. For example, calcium sulfate, commonly referred to as gypsum, is used in drywall.

Primary desalination produces a stream of purified water and a waste stream containing the salts removed from the groundwater. RO/NF waste stream and a solution of NaCl are fed separately to electrodialysis metathesis (EDM), which produces two concentrated salt streams, one rich in CaCl₂ and the other rich in Na₂SO₄. The diluate from the EDM returns to the RO/NF feed to recover additional water. The two concentrate streams produced by EDM mix to precipitate CaSO₄ and produce a supernatant that is rich in NaCl.

Membranes that selectively transport monovalent ions recover NaCl from the supernatant during electrodialysis (ED). Pretreatment of supernatant before ED occurs with the addition of Na₂CO₃ to precipitate CaCO₃. Recovered NaCl serves as a NaCl feed stream for the EDM. The supernatant, a solution comprising NaCl saturated in CaSO₄, is considered unsuitable for direct return to the EDM, because it contains excess calcium and sulfate. The presence of CaSO₄ in the supernatant can also lead to precipitation of CaSO₄ in the equipment used for NaCl recovery. This precipitation is exacerbated by decreasing solubility of CaSO₄ when NaCl is removed from a solution containing both salts. Addition of Na₂CO₃ to precipitate CaCO₃ is an effective way to reduce the calcium concentration of the supernatant. Softening the supernatant before ED treatment requires a lot of Na₂CO₃, which is rather expensive and produces a lot of CaCO₃ precipitate, which has low commercial value. The invention described herein reduces consumption of Na₂CO₃, because a larger portion of the calcium is removed as CaSO₄.

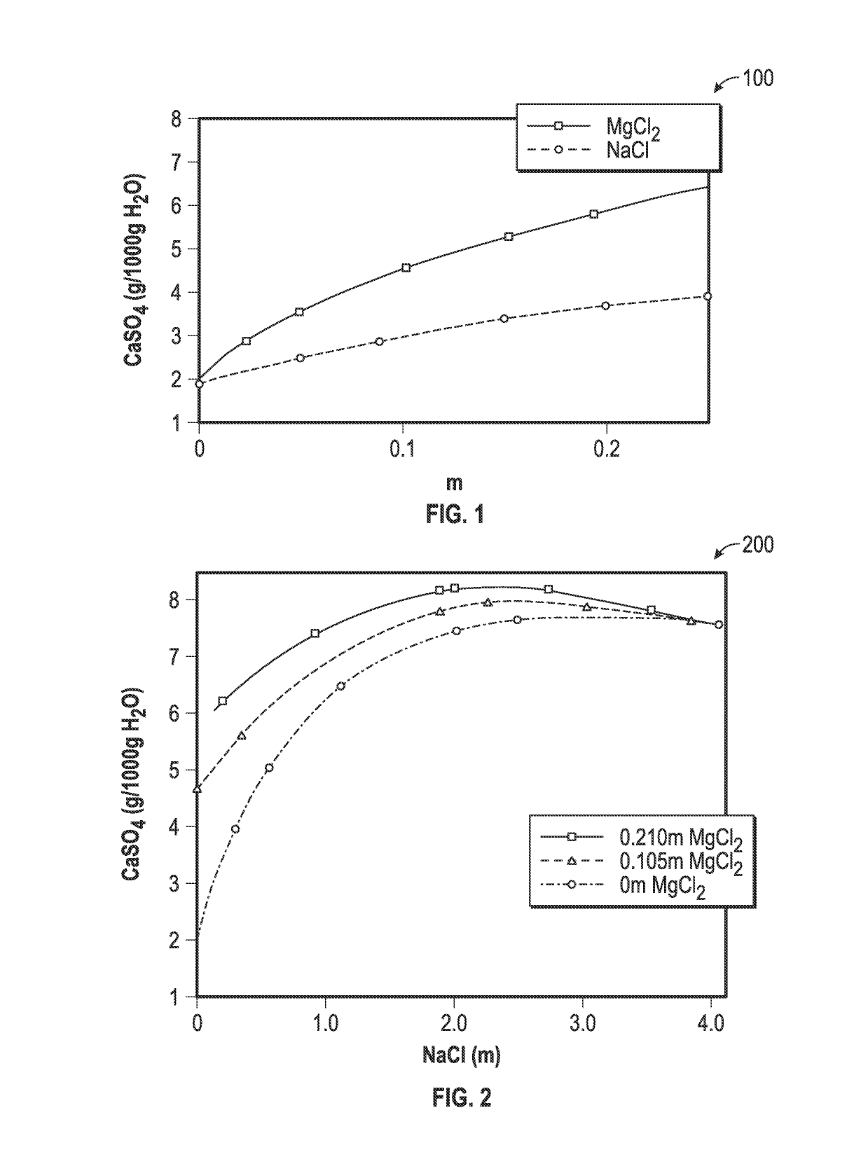

The presence of MgCl₂ and NaCl in solution results in increased CaSO₄ solubility. FIG. 1 illustrates an exemplary graphical illustration 100 of gypsum (CaSO₁) solubility at 70° C. in NaCl and MgCl₂ solutions, in accordance with the disclosed embodiments. FIG. 2 illustrates an exemplary graphical illustration 200 of gypsum (CaSO₄) solubility at 38° C. in NaCl solutions with increasing concentration of MgCl₂. The effects of those two solutes are additive. The solubility of CaSO₄ in pure water is about 2 g per kg of pure water. Solubility exceeding 8 g of CaSO₄ per kg of water is shown for certain mixtures of MgCl₂ and NaCl in the solution.

Addition of a slurry of Ca(OH)₂, commonly known as milk of lime, causes precipitation of Mg(OH)₂ from the CaCl₂-rich stream produced in the EDM. The added water promotes undesirable dilution of the CaCl₂-rich solution. However, it was demonstrated that addition of powdered Ca(OH)₂ produced the desired precipitation without dilution. Removal of magnesium from the CaCl₂-rich solution before mixing it with the Na₂SO₄-rich solution is beneficial, because the presence of magnesium raises the solubility of CaSO₄.

In a preferred embodiment of this invention related to recovery of NaCl from the supernatant of CaSO₄ precipitation, the CaCl₂-rich solution from the EDM is treated with powdered Ca(OH)₂ to precipitate Mg(OH)₂, which is processed further to produce a salable byproduct. Then, the CaCl₂-rich and Na₂SO₄-rich streams are combined in substantially stoichiometric proportions with respect to calcium and sulfate ions in a chamber to precipitate CaSO₄. The precipitation chamber preferably contains some solid CaSO₄ left over from a previous batch. The importance of batch operation will become clear in a subsequent discussion about the ratios of Na/Ca and Cl/SO₄ ions in the supernatant solution.

The batch of solution and previously precipitated CaSO₄ is agitated to promote contact between the calcium and sulfate ions in solution with the solid CaSO₄. The precipitate is presumed to be CaSO₄.2H₂O, but it will be called CaSO₄ herein. The precipitate is allowed to settle somewhat in order to form a clear supernatant containing NaCl and saturated with CaSO₄. The supernatant is preferably allowed to pass through a filter to remove particles of CaSO₄ that might remain suspended in the solution. Then the supernatant flows through a device that allows recovery of NaCl with lower concentrations of CaSO₄ in the recovered salt solution than in the supernatant. Devices that are known to purify NaCl solutions include nanofiltration (NF) and electrodialysis (ED) with membranes that are selectively permeable to monovalent ions. The description below is of ED for recovery of purified NaCl. This invention preferably recovers salt by either NF or ED.

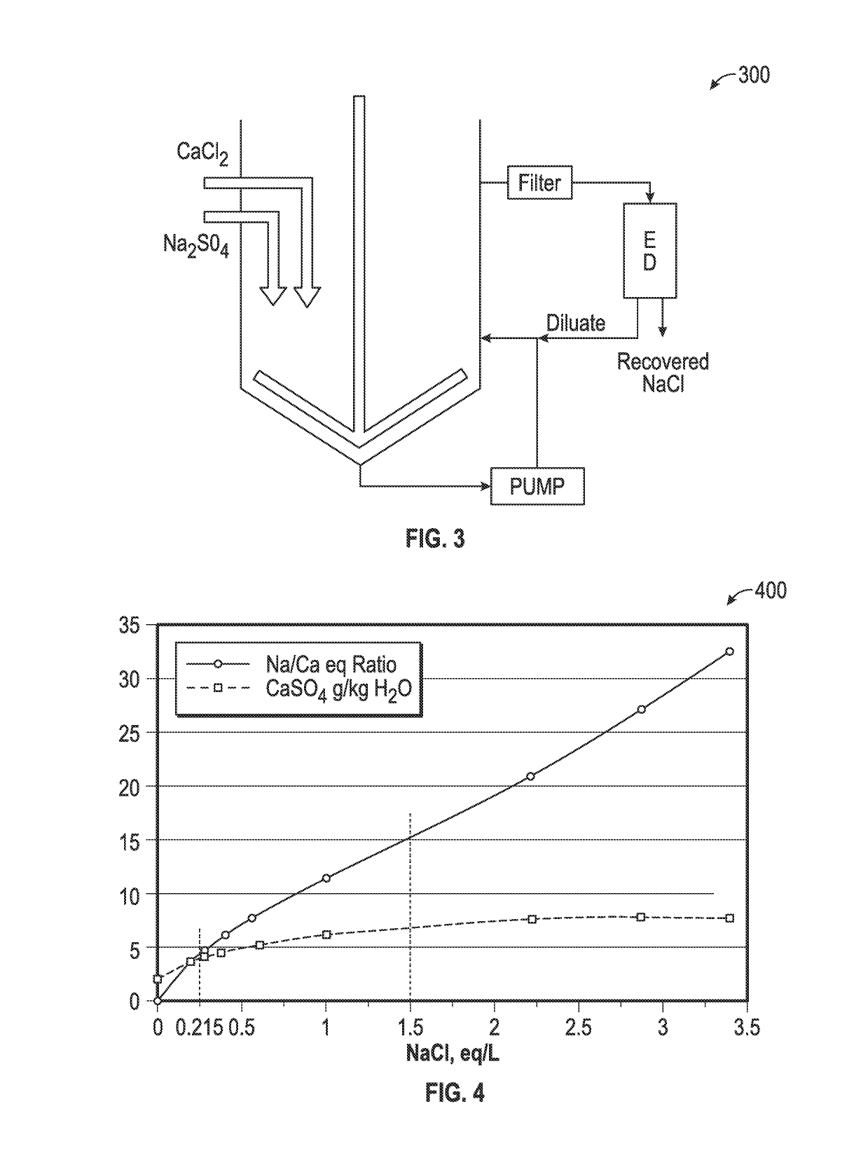

FIG. 3 illustrates an exemplary process flow diagram 300 of ED recovery of NaCl from a batch of supernatant, in accordance with the disclosed embodiments. A preferred embodiment of the invention utilizes an ED stack containing ion-exchange membranes that are selective to the transport of monovalent anions or cations. The NaCl-depleted supernatant, called diluate, is returned to the precipitation chamber as illustrated in FIG. 3, and the diluate is preferably mixed with CaSO₄ slurry in the bottom of the precipitation chamber. A preferred means of mixing the diluate with the slurry is removing some slurry from the precipitation chamber and mixing the slurry with the returning diluate as shown in FIG. 3. Mixing the diluate with removed slurry allows flexibility in selection of the point of return of diluate into the precipitation chamber.

Because the supernatant solution enters the ED saturated with CaSO₄, removal of NaCl causes the diluate to be somewhat supersaturated with CaSO₄. However, the slow kinetics of precipitation of CaSO₄ and the short residence time of the solution in the ED stack favor a delay in precipitation until the diluate enters the precipitation chamber where it comes into contact with the previously form precipitate that provides sites for crystallization of CaSO₄.2H₂O. The point of entry of the diluate is preferably in the bottom region of the precipitation chamber where it can have maximum contact with the previously formed precipitate. ED treatment of the batch of supernatant continues until a target concentration of NaCl is reached in the supernatant or until the Na/Ca ratio or the Cl/SO₄ ratio in the recovered NaCl solution drops to a target level.

Then a substantial portion of the batch of CaSO₄ slurry (particles of CaSO₄.2H₂O suspended in NaCl-depleted solution) is removed from the tank and the solid CaSO₄ is separated from the liquid by gravity settling, centrifugation, filtration or by any other solid-liquid separation process or combination of processes know in the art. If the CaSO₄ is for use that requires low NaCl content, the precipitate is washed with water of lower salinity than the ED diluate. A preferred source of wash water is permeate from the primary desalination. The wash water from cleaning of the CaSO₄ can be blended with the feed water to the desalination plant to avoid discharge.

The NaCl-depleted liquid can be disposed to a deep well or an evaporation pond, but a preferred means of dealing with the liquid is to blend it with product water from the desalination plant. The NaCl-depleted liquid can be blended with the feed water to the desalination plant, mixed with the feed to the EDM or blended with the product water. Returning this liquid to the process makes the ZDD process truly Zero Discharge Desalination. The NaCl-depleted liquid is preferably transferred to a storage tank from which it is pumped to the return point at a constant rate to avoid fluctuations in the flow rate and composition of the stream to which it is introduced.

Monovalent-ion-selective membranes are used in electrodialysis (ED) to purify and concentrate monovalent salt solutions. The largest application has been in the recovery of edible NaCl from seawater in Japan. The monovalent-anion-selective membranes blocks passage of SO₄²⁻ and the monovalent-cation-selective membranes block Mg²⁺, Ca²⁺, Sr²⁺, Ba²⁺ and Ra²⁺ to prevent precipitation of CaSO₄ or BaSO₄ in the concentrating streams of the ED and to prevent excess magnesium in the recovered salt. Monovalent-ion-selectivity is usually achieved by modification of the surface of a conventional ion-exchange membrane, for example, by applying a layer of anion-exchange polymer to a cation-exchange membrane. The effectiveness of the membranes at rejecting one ion and transporting another is defined quantitatively by the Relative Transport Number (RTN). For example, the RTN for sodium ions relative to calcium ions can be calculated as:

$$R T {N}_{Ca}^{Na} = \frac{flux Na}{flux Ca} / \frac{[ Na ]}{[ Ca ]} ,$$

where brackets indicate molar concentrations of ions in the ED diluate.

Monovalent-ion selectivity is more easily accomplished with anion-exchange membranes with RTN_{SO}_{₄}^{Cl}≈100 being reported compared to RTN_{Ca}^{Na} in the range of 5 to 10 being commonly reported. The preferred method for operating the ED is to supply no solution to the concentrate compartments other than the water that migrates with the ions through the membranes. When ignoring the transport of co-ions through the membranes, the ratio of sodium ions to calcium ions and the ratio of chloride ions to sulfate ions in the ED concentrate are proportional to the ratio of their fluxes through the membrane.

It is important to maintain low concentrations of calcium and sulfate in the recovered NaCl solution to be used in the EDM, because migration of calcium and sulfate ions through the membranes in the EDM stack can cause precipitation of CaSO₄ in the concentrate compartments of the EDM stack. Preliminary experiments on salt purity in EDM indicate that a Na/Ca ratio of at least 25 is required for the NaCl solution to avoid precipitation in the EDM, and a much higher ratio is preferred.

Operation of the ED in batch mode, rather than a feed-and-bleed mode, produces higher Na/Ca and Cl/SO₄ ratios in the NaCl recovered by ED. FIG. 4 illustrates that the solubility of CaSO₄ is about 2 g/kg H₂O (0.03 eq/L) when there is no NaCl in the solution. The presence of NaCl in the solution causes the solubility of CaSO₄ to rise to a maximum of 7.67 g/kg H₂O. However, the Na/Ca ratio rises at the higher concentrations of NaCl. The ratios for the upper curve in FIG. 4 are calculated from the solubility data (lower curve) and NaCl concentrations.

FIG. 4 illustrates an exemplary graphical illustration 400 of solubility of CaSO₄ at 28° C. in NaCl solutions and the resulting Na/Ca ratio, in accordance with the disclosed embodiments. The longer of the two vertical dashed lines in FIG. 4 shows the expected concentration of NaCl (1.5 eq/L) in the supernatant when the CaCl₂-rich concentrate and the Na₂SO₄-rich concentrate from the EDM are mixed. (The 1.5 eq/L is given as an example based on pilot plant experience. Larger values of NaCl concentration in the supernatant are possible when the EDM is operated with the higher purity of NaCl solution made possible by this invention.) The shorter dashed line shows the predicted concentration of NaCl (0.215 eq/L) after 90% of the NaCl is recovered by ED.

It can be seen that the equilibrium Na/Ca ratio drops from 15 to about 4. Thus, the purity of NaCl recovered by ED at the beginning of a batch will be substantially better than the purity at the end of the batch. The purity of the recovered NaCl would be as though it were recovered from a solution with an average Na/Ca ratio of 9.5.

Another mode of recovery in operation of the ED is the alternative feed-and-bleed mode. In a feed-and-bleed mode of operation, the CaCl₂-rich concentrate and the Na₂SO₄-rich concentrate from the EDM would be added continuously to the bottom of the precipitation chamber so that they contact the previously precipitated CaSO₄, and the supernatant would be drawn off continuously for treatment by ED. In the feed-and-bleed case, the solution being treated by the ED would have a constant Na/Ca ratio of 4 so the recovered NaCl solution would have a Na/Ca ratio less than half of that achievable with batch ED.

Further, batch treatment requires less electrical energy than feed-and-bleed treatment, because the higher concentration of salt in the depleting compartments of the ED at the beginning of the batch provides lower electrical resistance so the voltage applied to the ED stack can be lower at the beginning of the batch than at the end. With feed-and-bleed operation, the required voltage would be the same as the voltage at the end of a batch operation, because the NaCl concentration fed to the ED would have a constant value of 0.215 eq/L.

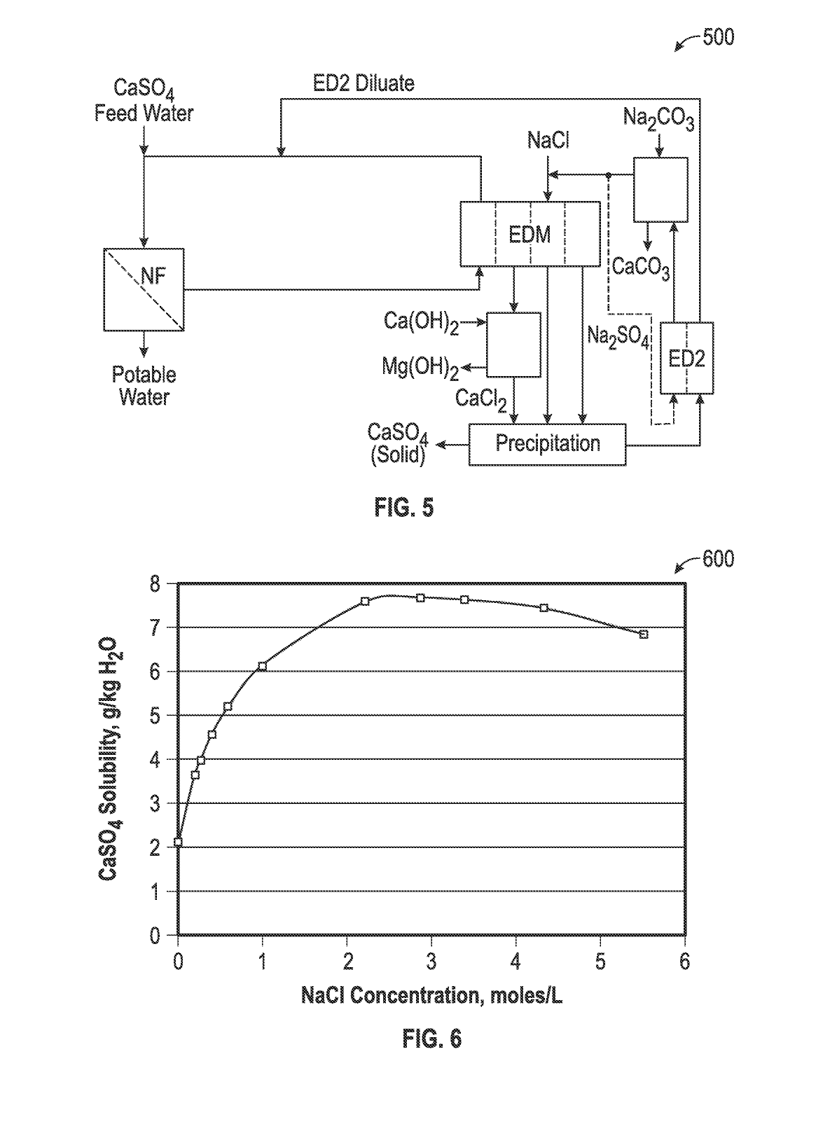

For some applications, the NaCl solution recovered by batch ED requires treatment to reduce its calcium content. Potential treatments include contact with chelating ion-exchange resins or weak-acid cation-exchange resins or by addition of a chemical agent that causes precipitation of calcium. Candidate chemical agents include carbonate, citrate, fluoride, metasilicate, oxalate and phosphate salts, and all of these are included in this invention. To avoid addition of extraneous ions to the system, a carbonate salt is chosen as the preferred chemical agent to be added, and more preferably Na₂CO₃. The amount of Na₂CO₃ required for calcium removal would be less than half of the amount required if the solution were treated by feed-and-bleed mode of operation. The Na₂CO₃ is preferably added as a powder to avoid dilution of the recovered NaCl solution. A preferred method for control of the powder addition is to measure the pH of the NaCl solution while the powder is being added. The addition is stopped when a substantial increase of the pH is observed. This substantial increase in the pH means that a slight excess of Na₂CO₃ powder has been added. The excess is remediated by addition of a small amount of the NaCl solution to consume the excess carbonate. The solid CaCO₃ is separated from the liquid by gravity settling, centrifugation, filtration, or by any other solid-liquid separation process or combination of processes know in the art. If the calcium level of the concentrate solution circulating through the ED becomes too high, a portion of the Ca-depleted solution from the carbonate precipitation can be blended with the circulating solution to reduce the calcium content to acceptable levels, as illustrated by the dashed line in FIG. 5.

FIG. 5 illustrates an exemplary flow diagram 500 of ZDD process with NaCl recovery in ED2, in accordance with the disclosed embodiments. This simplified diagram omits all of the pumps and circulating solutions flowing through the EDM and ED2 stacks, and it omits the duplicate tanks needed for precipitation of Mg(OH)₂, CaCO₃ and CaSO₄. Duplicate tanks are needed, because the EDM operates as a continuous process while the subsequent processes, precipitation of Mg(OH)₂, precipitation of CaSO₄, and precipitation of CaCO₃ are preferably operated as batch processes. Therefore, it is necessary to accumulate the required quantity of material into a tank before performing the batch operation. Consequently, at least two tanks are required for each of these batch processes.

Also omitted in FIG. 5 is a process for removing excess Na₂SO₄ by crystallization. Crystallization of Na₂SO₄ would be beneficial if there were an excess of sulfate in the water treated by the primary desalination process, including sulfate from sulfuric acid added to control pH in the system, compared to the sum of equivalents of calcium and magnesium. Similarly, if there is an excess of hardness, some of the Ca(OH)₂ for precipitation of Mg(OH)₂ if preferably replaced with NaOH. Alternatively, stoichiometric conditions for precipitation of CaSO₄ can be achieved by discarding an appropriate amount of the CaCl₂-rich or Na₂SO₄-rich solution, but that would mean that the process has a liquid discharge. Crystallization of Na₂SO₄ is preferably achieved by cooling a side stream of the concentrated solution to form crystals of Na₂SO₄.10H₂O. The crystals of Na₂SO₄.10H₂O can be further processed by heating above 33′C to cause dehydration to Na₂SO₄.

The EDM is preferably operated with the maximum concentrations in the CaCl₂-rich and Na₂SO₄-rich concentrate streams. Sometimes these streams are intentionally diluted to reduce the chances of precipitation of CaSO₄ in the concentrate streams due to migration of calcium ions or sulfate ions from the NaCl stream into the concentrate streams. The use of this invention improves the purity of the NaCl stream and consequently reduces the likelihood of unwanted precipitation. Moreover, the use of NaCl with higher purity allows operation of the EDM with reduced dilution of the CaCl₂-rich and Na₂SO₄-rich concentrate streams, which push the NaCl concentration to higher levels, and as indicated in FIG. 4, and allows recovery of NaCl with even higher purity. Further, operating the EDM with higher concentration in the Na₂SO₄-rich stream will facilitate the removal of excess Na₂SO₄ from that stream, either by reducing the flow rate of the side stream or by reducing the amount of cooling required to achieve crystallization.

Control of the composition of the batch solution being treated by ED is important to quality control of the recovered NaCl. Since the monovalent-anion-selective membranes exclude sulfate ions more effectively than monovalent-cation-selective membranes exclude calcium ions, the removal rate of calcium ions from the feed solution exceeds the removal rate of sulfate ions when the calcium and sulfate are present in equal ionic concentrations. If it is assumed that an optimum condition is to have equal amounts of calcium and sulfate in the feed solution to the ED, it would be necessary to provide supplemental calcium ions to the solution in order to avoid an imbalance in the proportions of calcium and sulfate ions. Therefore, a preferred method for controlling the solution composition by providing a means of measuring the concentration of calcium ions or the concentration of sulfate ions or both. With information on the solubility of CaSO₄ as a function of NaCl concentration and analytical information about the calcium or sulfate concentration or both, a control algorithm provides a signal to control an infusion pump that infuses the mixed Cl concentrate stream produced by the EDM and thus achieves the desired addition rate of calcium to match the rate of calcium removal through the cation-exchange membranes of the ED. The Orion 2120XP calcium Hardness Analyzer described at http://www.thermoscientific.com/ecomm/servlet/productsdetail_{—}11152_{—}12769462_-1 is an example of a means of determining the calcium level of the solution in real time. It is not necessary that the calcium and sulfate concentrations be maintained at equal levels throughout the batch. If specifications require a reduction in the sulfate level of the recovered NaCl, the control algorithm can be set to maintain the calcium level higher than the sulfate level.

Periodic reversal of the electric current in the ED stack is useful in this invention as a means of combating accumulation of CaSO₄ in the ED stack. Since the solubility of CaSO₁ would decrease in the diluate compartment due to removal of NaCl, as illustrated in FIG. 1, the conditions exist for crystals of CaSO₄ to grow in the depleting compartments. Furthermore, when this invention is practiced in commercial ED stacks that have long solution compartments with increased residence times, there is an increased likelihood of crystallization of CaSO₄ in the depleting compartments.

In a preferred embodiment of this invention, the ED stack is equipped with electrodes that allow reversal of the electric current, and the polarity of the electrodes is reversed after each batch treatment. Reversal of the polarity causes the electrical current to flow in the opposite direction, and the compartments that had been depleting compartments become concentrating compartments. When nascent crystals of CaSO₄ in the concentrating compartments are exposed to increasing NaCl concentrations, the increased solubility will cause CaSO₄ crystals to dissolve. The dissolution will add some calcium and sulfate ions to the recovered salt, but it is anticipated that the amounts will be small. The main purpose of the current reversal is to eliminate nascent crystals so that they do not become sites for further crystal growth, which could happen if the ED stack is used to treat multiple batches of supernatant without current reversal.

FIG. 6 illustrates an exemplary graphical illustration 600 of solubility of CaSO₄ in NaCl solutions at 23° C., in accordance with the disclosed embodiments. It should be noted from FIG. 6 that the solubility of CaSO₄ is highest and changes very little for NaCl solution concentrations in the range of 2.2 to 4.3 mol/L and typically the NaCl concentration in the recovered NaCl is close to 4 mol/L.

Nanofiltration (NF) membranes are characteristically more permeable to monovalent salts than to divalent salts and NF membranes have been used to soften water. However, a characteristic of NF membranes is that they are more permeable to water than to salt so the permeate solution has lower salt concentration than the feed solution. The batch process for NaCl recovery makes the use of NF more practical, because the NF permeate has higher salt content at the beginning of the batch. This invention includes the use of NF to recover a purified NaCl solution from the batch of NaCl solution contaminated with CaSO₄. Commercial NF membranes cover a broad spectrum of properties relating to theft permeability to NaCl and to calcium and sulfate ions. The NF membranes preferred for this process have the property of having high permeability to NaCl and the ability to reject calcium and sulfate ions.

Electrodialyis (“ED”) can produce a purified salt solution of a concentration higher than that required in the electrodialysis metathesis (“EDM”) device and nanofiltration (“NF”) can produce a purified salt solution with a concentration lower than that required for the EDM device. Referring to FIG. 3, the NF device can be located in one or more of three positions in the flow scheme. (1) The NF can draw its feed from the filtered solution from the stirred tank and return its concentrate to the stirred tank. (2) The NF can draw its feed from the filtered solution from the stirred tank and deliver its concentrate to the ED. (3) The NF can draw its feed from the diluate produced by the ED and return its concentrate to the stirred tank. The permeate solution from the NF is blended with the concentrate from the ED to produce a salt solution of the appropriate concentration for feeding to the EDM device. In cases where the quantity of salt recovered by the ED and NF is insufficient to meet the requirements of the EDM, supplemental crystalline salt is utilized in the ZDD process. The NF permeate can be utilized to dissolve the crystalline salt and produce a salt stream of appropriate concentration for feeding to the EDM.

It will be appreciated that variations of the above-disclosed and other features and functions, or alternatives thereof, may be desirably combined into many other different systems or applications. Furthermore, various presently unforeseen or unanticipated alternatives, modifications, variations or improvements therein may be subsequently made by those skilled in the art which are also intended to be encompassed by the following claims.

What is claimed is:

1. A method for recovering a purified soluble salt, comprising:
electrodialysis to recover a salt from an aqueous solution, wherein the aqueous solution comprises a soluble salt contaminated with a salt of limited solubility;
recovering a salt from the contaminated aqueous solution; and
purifying the contaminated salt into a purified soluble salt.

2. The method of claim 1 further comprising continuously withdrawing a stream of a batch solution of the soluble salt and the salt of limited solubility.

3. The method of claim 2 wherein a batch of the soluble salt solution is in contact with crystals of the salt of limited solubility.

4. The method of claim 1 further comprising treating a withdrawn stream of a batch solution with a salt recovery device capable of splitting the solution into two streams.

5. The method of claim 4 wherein a first stream of the batch solution is enriched in a soluble salt and a second stream of the batch solution is enriched in a salt of limited solubility.

6. The method of claim 4 wherein the salt recovery device comprises:
at least one ion-permeable membrane of the electrodialysis is more permeable to ions of the soluble salt than to ions of the salt of limited solubility; and
nanofiltration with a membrane that is more permeable to the ions of the soluble salt than to the ions of the salt of limited solubility.

7. The method of claim 1 further comprising returning a batch solution enriched with the salt of limited solubility from a salt recovery device to a batch of solution, wherein the returned solution contacts crystals of the salt of limited solubility.

8. The method of claim 1 further comprising collecting the solution enriched in the soluble salt from the salt recovery device, wherein the collected solution enriched in the soluble salt from the salt recovery device is further purified by addition of a chemical agent that causes precipitation of at least one ion of the salt of limited solubility.

9. The method of claim 1 wherein the purified soluble salt comprises sodium chloride., and wherein an ion of the salt of limited solubility comprises calcium and the chemical agent comprises a soluble carbonate salt.

10. A system for recovering a purified soluble salt, comprising:
electrodialysis utilized to recover a salt from an aqueous solution, wherein the aqueous solution comprises a soluble salt contaminated with a salt of limited solubility;
a salt recovered from the contaminated aqueous solution; and
a purified soluble salt purified from the contaminated salt.

11. The system of claim 10 further comprising a batch solution continuously withdrawn from a stream of a batch solution of the soluble salt and the salt of limited solubility.

12. The system of claim 11 wherein a batch of the soluble salt solution is in contact with crystals of the salt of limited solubility.

13. The system of claim 10 further comprising a withdrawn stream of a batch solution treated with a salt recovery device capable of splitting the solution into two streams.

14. The system of claim 13 wherein a first stream of the batch solution is enriched in a soluble salt and a second stream of the batch solution is enriched in a salt of limited solubility.

15. The system of claim 13 wherein the salt recovery device comprises:
at least one ion-permeable membrane of the electrodialysis is more permeable to ions of a soluble salt than to ions of a salt of limited solubility; and
nanofiltration with a membrane that is more permeable to the ions of the soluble salt than to the ions of the salt of limited solubility.

16. The system of claim 10 further comprising:
a batch solution enriched with the salt of limited solubility returned from a salt recovery device to a batch of solution, wherein the returned solution contacts crystals of the salt of limited solubility, and
a collected solution enriched in the soluble salt from the salt recovery device, wherein the collected solution enriched in the soluble salt from the salt recovery device is further purified by addition of a chemical agent that causes precipitation of at least one ion of the salt of limited solubility,

17. A system for recovering NaCl from the supernatant of CaSO₄ precipitation, comprising:
a CaCl₂-rich solution treated with powdered Ca(OH)₂ to precipitate Mg(OH)₂, a salable byproduct; and
a CaCl₂-rich stream and a Na₂SO₄-rich stream combined in substantially stoichiometric proportions with respect to calcium and sulfate ions in a chamber to precipitate CaSO₄ in the presence of additional solid CaSO₄ left from a previous batch.

18. The system of claim 17 further comprising:
an agitator to agitate the batch solution and previously precipitated CaSO₄ and promote contact between calcium and sulfate ions in solution with the solid CaSO₄; and
a clear supernatant containing NaCl and saturated with CaSO₄ wherein the supernatant passes through a filter to remove remaining particles of CaSO₄ suspended in solution.

19. The system of claim 17 further comprising:
a device for recovery of NaCl with lower concentrations of CaSO₄ in the recovered salt solution than in the supernatant and wherein the supernatant flows through the device, wherein the device comprises at least one of nanofiltration (NF) and electrodialysis (ED) with membranes that are selectively permeable for recovery of purified NaCl; and an ED stack containing ion-exchange membranes that are selective to the transport of monovalent anions or cations;

20. The system of claim 17 further comprising:
a NaCl-depleted supernatant, or diluate, returned to a precipitation chamber and mixing the diluate with CaSO₄ slurry in a bottom portion of the precipitation chamber for maximum contact with a previously-formed precipitate crystallization of CaSO₄.2H₂O, and continuing ED treatment of the batch of supernatant until a target concentration of NaCl is reached in the supernatant or until the Na/Ca ratio or the Cl/SO₄ ratio in the recovered NaCl solution drops to a target level; and
a CaSO₄ slurry batch comprising particles of CaSO₄.2H₂O suspended in NaCl-depleted solution, removed from the tank, and separating solid CaSO₄ from liquid by at least one of gravity settling, centrifugation, filtration or by any other solid-liquid separation process or combination of processes.

21. A system for recovering a purified soluble salt, comprising:
nanofiltration utilized to recover a salt from an aqueous solution, wherein the aqueous solution comprises a soluble salt contaminated with a salt of limited solubility;
a salt recovered from the contaminated aqueous solution; and
a purified soluble salt purified from the contaminated salt.

22. The system of claim 21 further comprising a nanofiltration device, wherein the nanofiltration device draws a feed of a filtered solution from diluate produced by an electrodialysis device.

23. The system of claim 21 further comprising a permeate solution, wherein the permeate solution is blended with a concentrate produced via electrodialysis, wherein a salt solution of an appropriate concentration is thereafter produced for feeding to an electrodialysis metathesis device.

24. The system of claim 21 further comprising a nanofiltration permeate, wherein the nanofiltration permeate is utilized to dissolve a crystalline salt and produce a salt stream of appropriate concentration for feeding to an electrodialysis metathesis device.
